(19) United States
(12) Patent Application Publication
(10) Pub. No.: US 2005/0198512 A1
(43) Pub. Date: Sep. 8, 2005

(54) System, method and program product for managing privilege levels in a computer system

(75) Inventor: Christopher N. Kline, Firestone, CO (US)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 10/791,321

(22) Filed: Mar. 2, 2004

(51) Int. Cl. H04K 1/00

(52) U.S. Cl. 713/182

(57) ABSTRACT

System and computer program product for determining if any of a plurality of groups may have an improper actual level of privilege. First program instructions compare members within each of the groups to a list of trusted individuals. Second program instructions determine if any groups with an actual privilege level higher than user level privilege have a member not on the list of trusted individuals, and if so, generate a report identifying the member not on the list of trusted individuals and the group in which the member is a member. Third program instructions determine if any group with an actual privilege level higher than user level privilege has a group name generally used or specified for a group with user level privilege, and if so, generate a report that the group with the higher actual privilege level has a group name generally used or specified for a group with user level privilege. Fourth program instructions determine if any groups with an actual privilege level higher than user level privilege have a group name not generally used or specified for a group with the higher level privilege, and if so, generate a report that the group with the higher actual privilege level has a group name not generally used or specified for a group with the higher level privilege. Consequently, the members of the groups with the higher actual privilege having a group name generally used for a group with user level privilege or a group name not generally used or specified for a group with the higher level privilege are revealed as trusted or not trusted.

### BACKGROUND OF THE INVENTION

The invention relates generally to computer systems, and deals more particularly with privilege levels of groups within a computer system.

“Privilege” levels or “authorization” levels are used to control access to program files and data files of a computer system. Some operating systems such as the Unix (tm licensed by X/Open Company Limited) operating system directly support only two broad classes of privilege: “super user” (or “root”) privilege and “user” privilege. (“Root” privilege is a term used in the Unix operating system whereas “super user” privilege is a more generic term.) Other operating systems such as Novell Netware operating system and Microsoft Windows operating system directly support “super user” privilege, “user” privilege and one or more intermediary levels of privilege, such as “application” level privilege. Nevertheless, the Unix operating system can be modified with known programming to create groups with “application” level privilege. Typically, a privilege is assigned to a group for each application and instance of an application such that the same group can be considered privileged by one application or application instance and unprivileged by another application or application instance. With some operating systems, such as the Unix operating system, each program and data file has a specified privilege level required for specified types of access, although the absence of a specified privilege level indicates “user” level of privilege. Generally, the higher the level of privilege the more files that can be read or changed by the privileged entity and the more control that can be exercised by the privileged entity. A person with “user” level of privilege is considered “untrusted”. Therefore, a person with “user” privilege can only execute user applications and access the user's own data. A person with “user” level privilege cannot generally modify configuration files or settings of the computer system or any of its applications or access sensitive data other than the user's own data. A person with “user” level privilege cannot compromise the security or operation of the system. Typically, a person with “application” level privilege for an application is “trusted” and can administer the application, i.e. modify configuration files and settings for the application. A person with “application” level privilege can also execute the program and any subprograms that are part of the application. A person with “super user” privilege is also “trusted” and can access or change almost any file in the system. For example, a person with “super user” privilege can access and change user password/shadow files which are considered very sensitive. A person with “super user” privilege for an application can also administer and execute the application.

With a Unix operating system, certain group names such as “staff”, “users” and “nobody”, are generally used for untrusted users, i.e. those with “user” privilege. Other operating systems likewise have certain group names which are generally used for “user” groups. Unix operating system and other operating systems also have certain group names which are generally used for “super user” groups such as “root” and “system”, and certain group names which are generally used for “application” groups, such as “mqm” and “db2admin”. (Group names will vary by application.). Occasionally, a systems administrator with “application” level privilege or “super user” privilege will change the privilege level of the “staff”, “user” or “nobody” group or other such group to a higher level of privilege for a particular application. Consequently, all people in the group will get more than “user” level privilege, and some may not warrant such privilege. It was previously known for a system administrator to periodically, manually enter commands into the computer to output the group names and their privilege levels to a text file. Then, the systems administrator would review the privilege level for each group name to determine if the group names typically used for user groups (as known by the systems administrator) have higher than “user” level privilege. Such a case would warrant further investigation. This manual process was time consuming when a large number of computers were checked. Also, some systems administrators did not know which group names were typically used for unprivileged users.

Another problem was that certain groups, regardless of their name, with “application” privilege or “super user” privilege may contain members who do not warrant such privilege. An administrator occasionally reviewed the members of privileged groups to determine if the administrator knew, through personal knowledge, that the members were all trusted individuals. This manual process was also time consuming when a large number of computers were checked. Also, some systems administrators did not know which group names were typically used for unprivileged users.

An object of the present invention is to identify and adjust any groups whose privilege level may be too high.

### SUMMARY OF THE INVENTION

The invention resides in a system and computer program product for determining if any of a plurality of groups may have an improper actual level of privilege. First program instructions compare members within each of the groups to a list of trusted individuals. Second program instructions determine if any groups with an actual privilege level higher than user level privilege have a member not on the list of trusted individuals, and if so, generate a report identifying the member not on the list of trusted individuals and the group in which the member is a member. Third program instructions determine if any group with an actual privilege level higher than user level privilege has a group name generally used or specified for a group with user level privilege, and if so, generate a report that the group with the higher actual privilege level has a group name generally used or specified for a group with user level privilege. Consequently, the members of the groups with the higher actual privilege having a group name generally used for a group with user level privilege are revealed as trusted or not trusted.

According to a feature of the present invention, the system and computer program also include fourth program instructions to determine if any groups with an actual privilege level higher than user level privilege have a group name not generally used or specified for a group with the higher level privilege. If so, the fourth program instructions generate a report that the group with the higher actual privilege level has a group name not generally used or specified for a group with the higher level privilege. Consequently, the members of the groups with the higher actual privilege having a group name not generally used or specified for a group with the higher level privilege are revealed as trusted or not trusted.

According to another feature of the present invention, the second program instructions determine if any group with an actual privilege level higher than user level privilege have all of its members on the list of trusted individuals. If so, the second program instructions generate a report that the group with the higher actual privilege level has all its members on the list of trusted individuals.

According to another feature of the present invention, fifth program instructions determine if all the members of the groups with the higher actual privilege having a group name generally used for a group with user level privilege are on the list of trusted individuals.

According to other features of the present invention, if any group with actual, higher level privilege has a name not generally used for a higher level privilege group, and there is at least one member of the group not on a list of trusted individuals, then either the actual privilege level of the group is lowered or the untrusted member is removed from the group.

### BRIEF DESCRIPTION OF THE FIGURES

FIG. 1 is a block diagram of a computer system in which the present invention is incorporated.

FIGS. 2(A), 2(B) and 2(C) form a flow chart illustrating operation of a privilege checking program within the computer system of FIG. 1 according to the present invention.

### DETAILED DESCRIPTION OF THE PREFERRED EMBODIMENTS

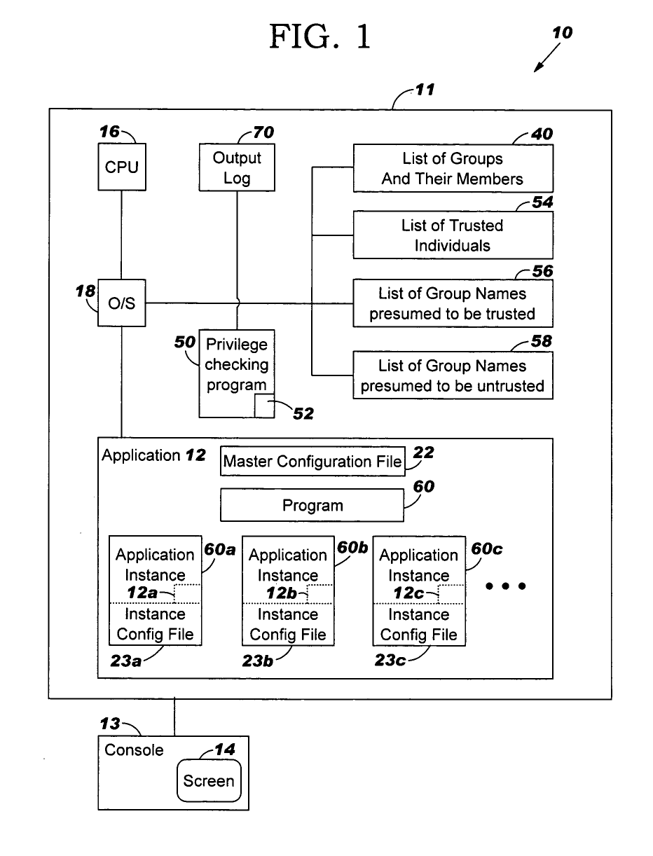

The present invention will now be described in detail with reference to the figures. FIG. 1 illustrates a computer system generally designated 10 in which the present invention is installed and used. System 10 comprises a computer 11 and a console 13 with a display screen 14. Computer 11 comprises a CPU 16, an operating system 18 and an application 12. By way of example, operating system 18 is Unix operating system (including IBM AIX, HP/UX, and Sun Solaris), although the present invention is applicable to other operating systems as well such as Microsoft Windows operating system, Linux (tm of Linus Torvalds) operating system, or Novell NetWare. Also by way of example, application 12 is a middleware program such as IBM MQ Series/Websphere MQ program, but the present invention is applicable to other types of programs as well.

After installation and invocation of application 12, users create multiple instances 12a,b,c of application 12. Each instance 12a,b,c of application 12 is a copy of application 12 and executes as a separate process with a separate configuration defined by a respective application-instance configuration file 23a,b,c. Each application instance 12a,b,c also contains a respective security management subsystem/authority manager 60a,b,c, which is configured with a respective security management profile to allow different operating system groups access to various portions of the application instance. For example, according to a security management profile for the respective application instance, one group of members has only “application user” level privilege and is only authorized to execute the respective application instance (such as to send and retrieve messages with the WebSphere MQ middleware application). Another group of users has “application administrator” level of privilege and is authorized to change application configuration, change privilege assignments of the groups, change privilege levels required to access specific files, and execute the respective application instance. All other operating system groups automatically fall into a “global unprivileged” category of groups and do not have access to execute or administer the application.

Computer 11 also includes a master configuration file 22 for application 12. This file is created by the application at installation time and is updated whenever a new application instance is created. The master configuration file 22 specifies the name of each application instance that has been created, the location for each application instance and/or application-instance configuration file, global defaults for each application instance if not otherwise specified, etc. Upon installation of application 12, the systems administrator may modify master configuration file 22, if necessary. In the illustrated embodiment, a person has “user” privilege and can execute the application 12. In an operating system environment which permits an intermediary, “application” privilege level (such that an application and its permissions can be controlled by a non-superuser), another person has “application” privilege level and is authorized to change privilege assignments of the groups involved with the application, change privilege levels required to access specific files within or associated with the application, administer the application, i.e. modify configuration files and settings for the application, modify the application master-configuration file 22 for application 12, administer application 12, and execute the application. Another person has “super user” privilege and can modify any file on the system, modify permissions for any file on the system, modify group names and memberships, and so forth, thus giving access to administer and execute application 12, if necessary. (Some operating system environments also recognize a “nobody” class, which has no privilege at all.)

Computer 11 maintains in memory a list 40 of all group names for all programs (i.e. operating system 18, application 12 and application instances 12a,b,c) in computer 11, and the members in each group. Computer 11 also maintains in memory a list 54 of trusted individuals, i.e. individuals who have been registered as systems administrators, application administrators, or some other capacity which is trusted to affect security and operation of the computer. (List 40 is a prior art Unix file.) Computer 11 also maintains in memory a list 56 of group names presumed to be super user groups or application groups and trusted, based on the name itself. For example, the group names, “root”, “system”, and “admin” are presumed to be trusted in the Unix environment because they are created by the operating system at installation time and are known in the industry to be reserved for system administrator-use only. In addition, applications running on computer 11 may also have group names that are generally known in the industry for groups which administer security for the application. These application groups may be broadly divided into application-administration (i.e. a super-user group at the application, not system level) and application-user (i.e. restricted to use or access, but not administer the application) classes. In the illustrated embodiment, a person with application-level or system-level super user privilege maintains list 54. Computer 11 also maintains in memory a list 58 of group names presumed to be user groups and untrusted, based on the name itself. For example, the group names, “staff”, “users”, “nobody” are presumed to be untrusted user groups because they generally contain a list of all users on the computer, i.e. users other than application level groups and systems administrators, or they are generally known in the industry to be reserved for “zero permissions” groups. In the illustrated embodiment, a person with application-level or system-level super user privilege maintains list 58. The presumed “higher” privileges, i.e. “super user”, “application” or the like, for the groups in lists 56 and 58 are not necessarily correct, i.e. do not necessary reflect the actual privileges assigned to the respective groups for any or all of the application instances 12a,b,c or application 12. Lists 54, 56 and 58 collectively form a “configuration file” for a privilege checking program 50, described below.

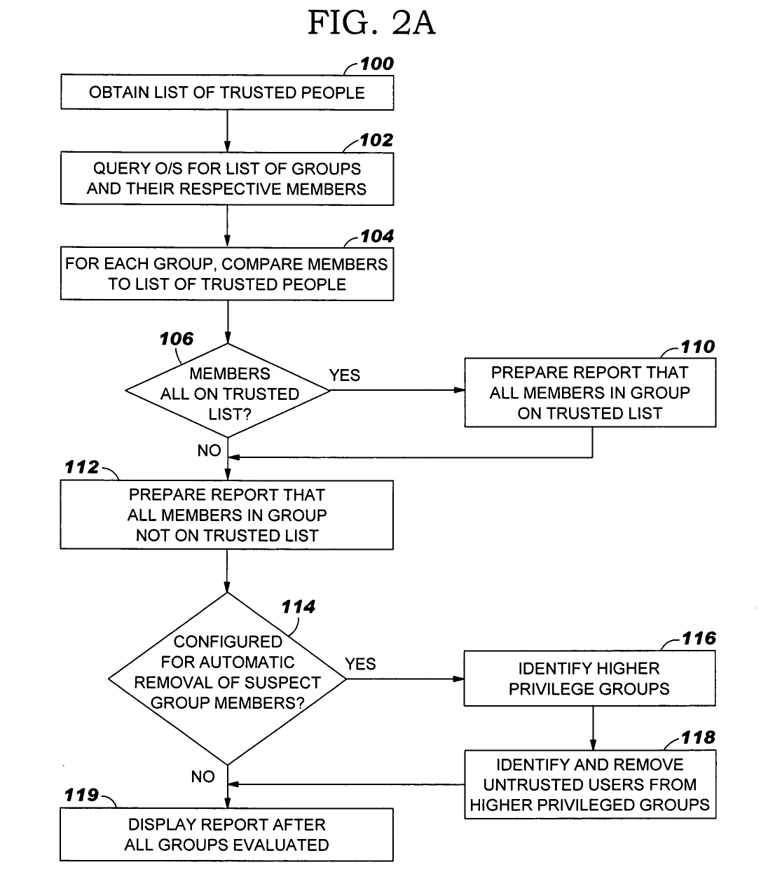

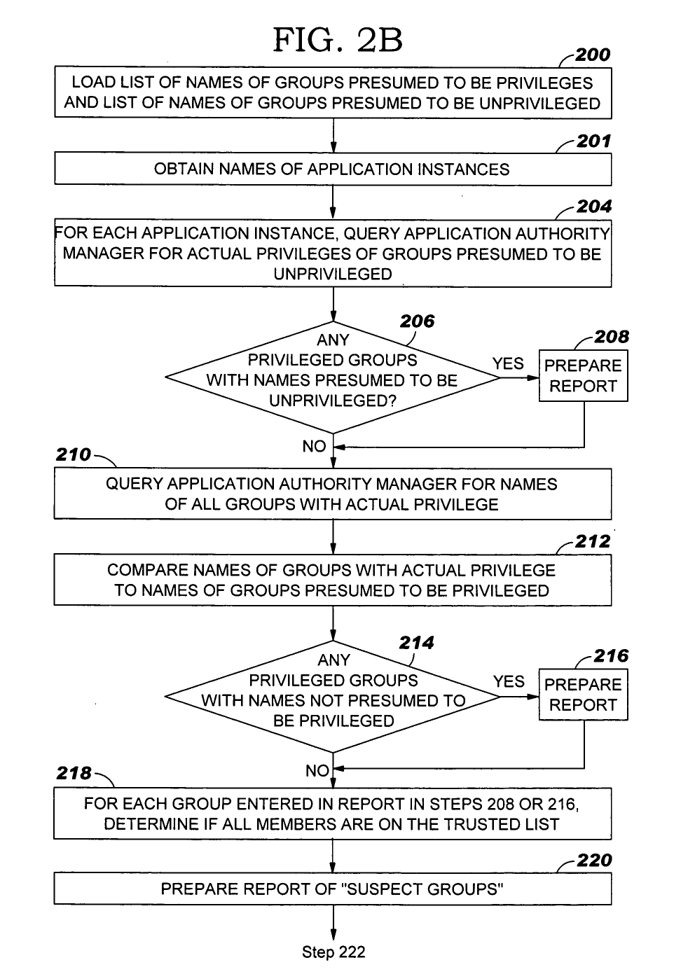

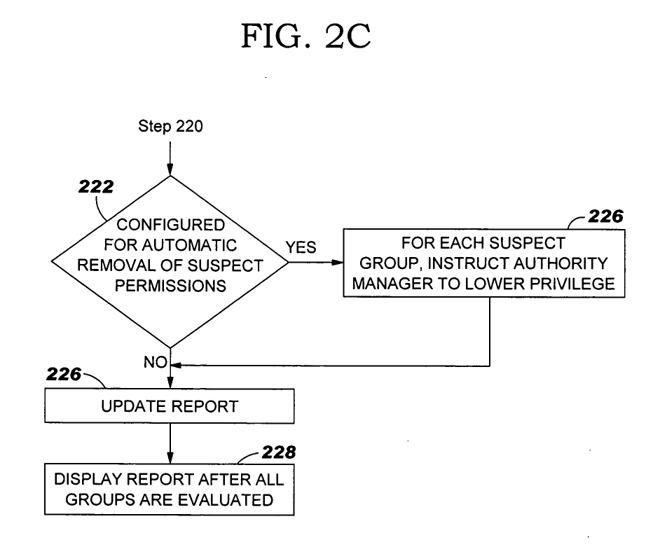

Privilege checking program 50 in accordance with the present invention has been loaded into computer 11 to review privileges of groups. As described in more detail below with reference to FIGS. 2(A), 2(B) and 2(C), privilege checking program 50 identifies as suspect (a) groups with actual, higher privilege whose names are generally associated with untrusted, user groups, and (b) groups with actual, higher privileges whose names are not generally associated with trusted groups. Privilege checking program 50 also determines which of these groups only contain members on the trusted list and which of these groups contain one or more members that are not on the trusted list. Consequently, for any suspect group, the systems administrator can readily determine if all the members of the suspect group are presumed to be trusted. In which case, the suspect group is probably assigned a correct privilege level.

FIG. 2(A) illustrates a function of privilege checking program 50 which automatically determines if any groups contain members who are not listed on the trusted list 54. Such groups may not warrant super user or application privilege if so assigned, as described below. The privilege checking program 50 is scheduled for periodic execution, such as monthly, based on a cron file. In step 100, the privilege checking program queries the operating system 18 for the list 54 of trusted individuals. Then, the privilege checking program queries the operating system 18 for the list 40 of all groups and the members in each group (step 102). For each group related to a specific application, the privilege checking program 50 performs steps 104-112, as follows. In step 104, the privilege checking program 50 compares the members of each group to the list 54 of trusted individuals. If all the members of the group appear in the list 54 of trusted individuals (decision 106, yes branch), then the privilege checking program 50 writes an entry in a report in a log 70 that all the members in this group are confirmed to be trusted (step 110). Referring again to decision 106, no branch, if any of the members of the group do not appear on the list of trusted individuals, then the privilege checking program 50 writes an entry in the report that all the member of the group are not confirmed to be trusted, and lists the name of the group and the names of its members who do not appear on the list 54 of trusted individuals (step 112). After steps 110 and 112, the privilege checking program 50 loops back to step 104 to repeat the foregoing analysis and report for the next group.

There is an optional configuration of program 50 (decision 114, yes branch) where program 50 seeks to remove from any higher privileged group (i.e. super user or application level), any members not on the list 54 of trusted individuals. In this configuration, program 50 identifies from the application instance configuration files those groups with higher level privilege (step 116). Then, program 50 determines if any such higher level privilege groups have any (suspect) member(s) not on the list 54 of trusted individuals (step 118). If so, program 50 automatically instructs the operating system to remove the suspect member from membership in the higher privileged group(s) (step 118), and the application instance configuration files are updated accordingly. As a result, only members known to be trusted remain in the higher privileged groups. Any actions taken in step 118 are then written to the report in the log. After all the groups have been so analyzed, the privileged checking program 50 displays the report to the administrator (step 119).

FIGS. 2(B) and 2(C) illustrates another function within privilege checking program 50 which automatically determines if “application” level privilege or “super user” level privilege has been granted to any group having a name that is generally used or specified for untrusted, user groups. This function also determines if any groups with “application” level privilege or “super user” privilege have names not generally used or specified for such higher privileged groups. In step 200, privilege checking program 50 loads from list 56 the names of groups presumed to be trusted (i.e. “super user” level privilege or “application” level privilege) and from list 58 the names of groups presumed to be untrusted (i.e. “user” level privilege). Next, privilege checking program 50 queries the operating system for the names of the application instances 12a,b,c (step 201). The operating system obtains these names from the master configuration file 50. Next, privilege checking program 50 performs the following steps 204-216 for each application instance (because the privilege assignments can vary by application instance). Privilege checking program 50 supplies the application authority manager program 60 with the names of the groups from list 58 presumed to be untrusted such as “user”, “nobody” or “staff”, and asks the application authority manager program 60 for the actual privilege levels of these groups (step 204). The actual privileges levels can be “super user” privilege, “user” privilege and in operating systems which permit intermediary levels of privilege, “application” privilege or the like. The application authority manager program 60 obtains the actual privilege level for each group listed in list 58 from the respective application instance under evaluation. The application authority manager program 60 returns the actual privilege level for each such group. From the response of the application authority manager program 60, the privilege checking program checks if any of these groups actually have “super user” privilege or “application” privilege (or some other privilege higher than “user” privilege) (decision 206). If so, the privilege checking program prepares a report indicating that such group(s) has (or have) higher privilege than “user” privilege and was (or were) not expected to have higher privilege based on the name of the group (step 208). It will also include the privileges (i.e. objects for which privileges are granted) in the report for the administrator to review.

Referring again to decision 206, no branch, if there are no groups with actual higher privilege having the same name as a presumed “user” group found in list 58, then there is no suspicion at this time of a misnamed group, and the privilege checking program 50 proceeds to the next test. So, the privilege checking program queries the application authority manager program 60 for the names of all groups associated with the application instance with actual privilege level of “super user” or “application” level (or some other privilege higher than “user” privilege) (step 210). The application authority manager program obtains this information from the application instance configuration file for the application instance under evaluation. Then, privilege checking program 50 compares the names of the groups with actual, higher level privilege to the names of groups in list 56 presumed to be higher level privileged (step 212). If any of the group names obtained from the application authority manager program as having actual higher privileged are not found in the list 56 of group names presumed have higher privilege, then the privilege checking program makes an entry in a record that the group is higher level privileged and does not have a name generally used for higher level privilege (step 216). The foregoing steps 204-216 are then repeated for the next application instance. After steps 204-216 have been performed for all of the application instances, for each group entered into the report in steps 208 or 216, the privilege checking program 50 determines if all the members of the group are on the trusted list (step 218). Step 218 is performed by checking the members of these groups against the list of trusted people obtained in step 100. After step 218, the privilege checking program makes an entry in the report of which of the suspect groups, i.e. those identified in decision 206, yes branch or decision 214, yes branch, have all their members in the trusted list and which do not (step 220). In the former case, the level of suspicion of an improper privilege assignment is reduced. In the latter case, the level of suspicion of an improper privilege assignment is increased.

There is another, optional configuration of program 50 (decision 222, yes branch) where program 50 seeks to lower the permission of any higher privileged group (i.e. super user or application level) which have names generally used for user level groups or not generally used for privileged groups, where the groups have one or more untrusted members. The identities of these higher privileged groups are contained in the report written in steps 208 and 216. Those high privileged groups (reported in step 208 or 216) which contain members not on the list 54 of trusted individuals are identified in the report in step 220 as “suspect”. In this optional configuration of program 50, program 50 instructs the application authority manager to lower the permissions of these suspect groups (of the report of step 220) to user level privilege (step 224). Any actions taken in step 224 are then written to the report in the log (step 226). After all the groups have been so analyzed, the privileged checking program 50 displays the report to the administrator (step 228).

In an alternate embodiment of the present invention, steps 218 and 220 are done manually, whereby the user visually compares the suspect groups reported in steps 208 and 216 to the reports generated in steps 110 and 112 to determine which of the suspect groups have all their members on the trusted list. Thus, in either embodiment of the present invention, with the functions of FIGS. 2(A) and 2(B), privilege checking program 50 identifies groups that are suspected of having improper names/elevated privilege assignments, those groups with members that are all on the list of trusted individuals and those groups with members that are not all on the list of trusted individuals. Consequently, for any suspect group, the systems administrator can readily determine if all the members of the suspect group are trusted. In which case, the suspect group is probably assigned a correct, elevated privilege level.

Based on the foregoing, a system, method and program product for identifying potentially misnamed groups with improper, elevated privileges have been disclosed. However, numerous modifications and substitutions can be made without deviating from the scope of the present invention. Therefore, the present invention has been disclosed by way of illustration and not limitation, and reference should be made to the following claims to determine the scope of the present invention.

1. A computer program product for determining if any of a plurality of groups may have an improper actual level of privilege, said computer program product comprising:
a computer readable medium;
first program instructions to compare members within each of said groups to a list of trusted individuals;
second program instructions to determine if any groups with an actual privilege level higher than user level privilege have a member not on the list of trusted individuals, and if so, generate a report identifying said at least one member not on the list of trusted individuals and the group in which said at least one member is a member; and
third program instructions to determine if any group with an actual privilege level higher than user level privilege has a group name on a list of group names generally used for a group with user level privilege, and if so, generate a report that said group with the higher actual privilege level has a group name generally used for a group with user level privilege, such that the members of said groups with the higher actual privilege having a group name generally used for a group with user level privilege are revealed as trusted or not trusted; and wherein
said first, second and third program instructions are recorded on said medium.

2. A computer program product as set forth in claim 1 wherein there are a plurality of applications or application instances, and a same group can be assigned different privilege levels for involvement with different applications or application instances; and said third program instructions makes its determination separately for each application or application instance.

3. A computer program product as set forth in claim 1 further comprising:
fourth program instructions to determine if any groups with an actual privilege level higher than user level privilege have a group name not on a list of group names generally used for a group with the higher level privilege, and if so, generate a report that said group with the higher actual privilege level has a group name not on a list of group names generally used for a group with the higher level privilege, such that the members of said groups with the higher actual privilege having a group name not generally used for a group with the higher level privilege are revealed as trusted or not trusted; and wherein
said fourth program instructions are recorded on said medium.

4. A computer program product as set forth in claim 1 wherein said second program instructions determine if any group with an actual privilege level higher than user level privilege have all of its members on the list of trusted individuals, and if so, generate a report that said group with the higher actual privilege level has all its members on the list of trusted individuals.

5. A computer program product as set forth in claim 1 further comprising fourth program instructions to determine if all the members of said groups with the higher actual privilege having a group name generally used for a group with user level privilege are on the list of trusted individuals; and wherein said fourth program instructions are recorded on said medium.

6. A computer system for determining if any of a plurality of groups may have an improper actual level of privilege, said computer system comprising:
means for comparing members within each of said groups to a list of trusted individuals;
means for determining if any groups with an actual privilege level higher than user level privilege have a member not on the list of trusted individuals, and if so, generate a report identifying said at least one member not on the list of trusted individuals and the group in which said at least one member is a member; and
means for determining if any group with an actual privilege level higher than user level privilege has a group name on a list of group names generally used for a group with user level privilege, and if so, generate a report that said group with the higher actual privilege level has a group name generally used for a group with user level privilege, such that the members of said groups with the higher actual privilege having a group name generally used for a group with user level privilege are revealed as trusted or not trusted.

7. A computer system as set forth in claim 6 wherein there are a plurality of applications or application instances, and a same group can be assigned different privilege levels for involvement with different applications or application instances; and said means for determining if any group with an actual privilege level higher than user level privilege has a group name generally used for a group with user level privilege makes its determination separately for each application or application instance.

8. A computer system as set forth in claim 6 further comprising:
means for determining if any groups with an actual privilege level higher than user level privilege have a group name not on a list of group names generally used for a group with the higher level privilege, and if so, generate a report that said group with the higher actual privilege level has a group name not generally used for a group with the higher level privilege, such that the members of said groups with the higher actual privilege having a group name not generally used for a group with the higher level privilege are revealed as trusted or not trusted.

9. A computer system as set forth in claim 6 wherein said means for determining if any groups with an actual privilege level higher than user level privilege have a member not on the list of trusted individuals determines if any group with an actual privilege level higher than user level privilege have all of its members on the list of trusted individuals, and if so, generates a report that said group with the higher actual privilege level has all its members on the list of trusted individuals.

10. A computer system as set forth in claim 6 further comprising means for determining if all the members of said groups with the higher actual privilege having a group name generally used for a group with user level privilege are on the list of trusted individuals.

11. A computer program product for determining if any of a plurality of groups may have an improper actual level of privilege, said computer program product comprising:
a computer readable medium;
first program instructions to compare members within each of said groups to a list of trusted individuals;
second program instructions to determine if any groups with an actual privilege level higher than user level privilege have a member not on the list of trusted individuals, and if so, generate a report identifying said at least one member not on the list of trusted individuals and the group in which said at least one member is a member; and
third program instructions to determine if any groups with an actual privilege level higher than user level privilege have a group name not on a list of group names generally used for a group with the higher level privilege, and if so, generate a report that said group with the higher actual privilege level has a group name not generally used for a group with the higher level privilege, such that the members of said groups with the higher actual privilege having a group name not generally used for a group with the higher level privilege are revealed as trusted or not trusted; and wherein
said first, second and third program instructions are recorded on said medium.

12. A computer program product as set forth in claim 11 wherein there are a plurality of applications or application instances, and a same group can be assigned different privilege levels for involvement with different applications or application instances; and said third program instructions makes its determination separately for each application or application instance.

13. A computer program product as set forth in claim 11 wherein said second program instructions determine if any group with an actual privilege level higher than user level privilege have all of its members on the list of trusted individuals, and if so, generate a report that said group with the higher privilege level has all its members on the list of trusted individuals

14. A computer program product as set forth in claim 11 further comprising fourth program instructions to determine if all the members of said group with the higher actual privilege having a group name not generally used for a group with higher level privilege are on the list of trusted individuals; and wherein
said fourth program instructions are recorded on said medium.

15. A computer program product for managing privileges of groups, said computer program product comprising:
a computer readable medium;
first program instructions to compare members within each of said groups to a list of trusted individuals;
second program instructions to determine if any groups with an actual privilege level higher than user level privilege have a member not on the list of trusted individuals, and if so, remove said member not on the list of trusted individuals from said group; and wherein
said first and second program instructions are recorded on said medium.

16. A computer program product for managing privileges of groups, said computer program product comprising:
a computer readable medium;
first program instructions to determine if any group with an actual privilege level higher than user level privilege has a group name on a list of group names generally used for a group with user level privilege or no privilege; and
second program instructions, responsive to a determination of a group with an actual privilege level higher than user level privilege with a group name generally used for a group with user level privilege or no privilege, to compare members of such group to a list of trusted individuals, and if any member(s) of such group do not appear on said list of trusted individuals, remove said member(s) from such group that do not appear on the said list of trusted individuals; and wherein
said first and second program instructions are recorded on said medium.

17. A computer program product for managing privileges of groups, said computer program product comprising:
a computer readable medium;
first program instructions to determine if any group with an actual privilege level higher than user level privilege has a group name not on a list of group names generally used for a group with privilege level higher than user level privilege; and
second program instructions, responsive to a determination of a group with an actual privilege level higher than user level privilege with a group name not generally used for a group with privilege level higher than user level privilege, to compare members of such group to a list of trusted individuals, and if any member(s) of such group do not appear on said list of trusted individuals, lower the actual privilege level of said group; and wherein
said first and second program instructions are recorded on said medium.
